(19) United States
(12) Patent Application Publication
(10) Pub. No.: US 2026/0045961 A1
(43) Pub. Date: Feb. 12, 2026

(54) SYSTEM FOR PREPROCESSING FOR ELIMINATING INTERFERENCE WITHIN ADJACENT RANGE OF ANALOG SIGNAL OF HDR AND CDR

(71) Applicant: RF2DIGITAL INC., Seongnam-si, Gyeonnggi-do (KR)

(72) Inventors: Seong Jun KIM, Seoul (KR); Sung Hyun YOON, Gwangju-si (KR)

(73) Assignee: RF2DIGITAL INC., Seongnam-si, Gyeonggi-do (KR)

(21) Appl. No.: 19/134,347

(22) PCT Filed: Nov. 5, 2024
(86) PCT No.: PCT/KR2024/017256

§ 371 Date: May 30, 2025

(30) Foreign Application Priority Data
Aug. 6, 2024 (KR) 10-2024-0104390

(51) Int. Cl. H04B 1/10; H04B 1/7107

(52) U.S. Cl. CPC H04B 1/1027; H04B 1/7107; H04B 2001/1045

(57) ABSTRACT

Disclosed is a preprocessing system for eliminating interference within an adjacent range of analog signals of Hybrid Digital Radio (HDR) and Conventional Digital Radio (CDR). The present embodiment provides a preprocessing system for eliminating interference within an adjacent range of analog signals of HDR and CDR, which is capable of restoring a signal using the symmetry of the analog signals during a process of receiving the analog signals of HDR and CDR, additionally determining whether a signal has noise by utilizing a frequency modulation (FM) phase property of the signal, and eliminating interference within the adjacent range of the analog signals through a single path without beamforming (two or more paths).

### TECHNICAL FIELD

Embodiments of the present invention relate to a preprocessing system for eliminating interference within an adjacent range of analog signals of Hybrid Digital Radio (HDR) and Conventional Digital Radio (CDR).

### BACKGROUND ART

The content described below simply provides background information related to the present embodiment and does not constitute the related art.

CDR stands for Conventional Digital Radio or China Digital Radio.

Digital Audio Broadcasting (DAB) is a European standard, Digital Radio Mondiale (DRM) is a Third World standard, Hybrid Digital Radio (HDR) is an American standard, and CDR is a Chinese standard.

HDR is a radio broadcasting technology for providing a mix of analog and digital broadcasting. HDR is a digital radio method manufactured under license by iBiquity Digital Corporation in the United States.

As illustrated in FIG. 1, in frequency modulation (FM) broadcasting in the United States, radio signals are transmitted in 200 kHz units. In HDR, a method of mixing existing FM signals (N) with digital signals (N) and transmitting the mixed signals is used.

In other words, in HDR, identical digital radio signals are attached to both sidebands of analog FM signals, and these signals are transmitted. A lower digital sideband (LDS) and an upper digital sideband (UDS) of HDR are symmetrical to each other, and the HDR is designed to be listenable even when only one LDS or UDS is completely restored.

In the United States, frequencies are managed so that neither sideband of an HDR digital signal is affected.

As illustrated in FIG. 2A, interference generally occurs within an adjacent range only in one sideband. When interference occurs within an adjacent range only in one sideband, signals are restored using signals in the other sideband that is not affected by the interference.

However, there is a problem that when received signals of an adjacent channel are significantly higher than received signals of an original channel, it is impossible to restore the signals because the received signals of the adjacent channel are outside the range of signals that can be expressed digitally.

As illustrated in FIG. 2B, when signals cross a border or region, degradation occurs due to the adjacent channel in both an LDS and a UDS. When degradation occurs in both sidebands, there is a problem of not only the degradation due to the mobility performance but also difficulty in restoration due to a low signal-to-noise ratio (SNR) of a digital stage in an adjacent channel.

### DETAILED DESCRIPTION OF INVENTION

### Technical Problem

The present embodiment is directed to providing a preprocessing system for eliminating interference within an adjacent range of analog signals of Hybrid Digital Radio (HDR) and Conventional Digital Radio (CDR), which is capable of restoring signals using the symmetry of the analog signals during a process of receiving the analog signals of HDR and CDR, additionally determining whether signals have noise by utilizing a frequency modulation (FM) phase property of the signals, and eliminating interference within the adjacent range of the analog signals through a single path without beamforming (two or more paths).

### Technical Solution

One aspect of the present embodiment provides a preprocessing system which includes a Conventional Digital Radio (CDR)/Hybrid Digital Radio (HDR) radio frequency (RF) reception unit configured to receive an RF signal of CDR or HDR, a data folding unit configured to recognize interference as noise when the interference occurs in an upper digital sideband (UDS) or lower digital sideband (LDS) within an adjacent range of an analog signal (N) of the CDR or HDR or when interference occurs in both the UDS and the LDS and use symmetry of analog signals (N−1 and N+1) in which the interference has occurred to separate the analog signals into symmetrical regions based on a center of the analog signals by using a data folding method, and a CDR/HDR restoration unit configured to restore a signal by eliminating the interference on the basis of the symmetrical regions.

### Advantageous Effects

As described above, according to the present embodiment, it is possible to restore signals using the symmetry of the analog signals during a process of receiving the analog signals of Hybrid Digital Radio (HDR) and Conventional Digital Radio (CDR), additionally determine whether signals have noise by utilizing a frequency modulation (FM) phase property of the signals, and eliminate interference within the adjacent range of the analog signals through a single path without beamforming (two or more paths).

### DESCRIPTION OF DRAWINGS

FIGS. 1 and 2 are diagrams for describing the characteristics of Hybrid Digital Radio (HDR) according to the related art.

FIG. 3 is a diagram illustrating a method of restoring a signal by eliminating interference occurring with an upper digital sideband (UDS) within an adjacent range of an analog signal using a data folding method according to the present embodiment.

FIG. 4 is a diagram illustrating simulation results for a method of restoring a signal by eliminating interference occurring with a UDS within an adjacent range of an analog signal using a data folding method according to the present embodiment.

FIG. 5 is a diagram illustrating a method of restoring a signal by eliminating interference occurring with a lower digital sideband (LDS) within an adjacent range of an analog signal using a data folding method according to the present embodiment.

FIG. 6 is a diagram illustrating a method of restoring a signal by eliminating interference occurring with an LDS and a UDS within an adjacent range of an analog signal using a data folding method according to the present embodiment.

FIG. 7 is a diagram illustrating a starting point of a data folding method according to the present embodiment.

FIG. 8 is a diagram illustrating a process of restoring analog signals of HDR and CDR according to the present embodiment.

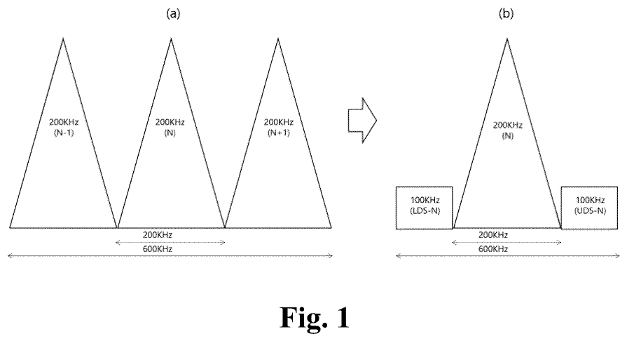

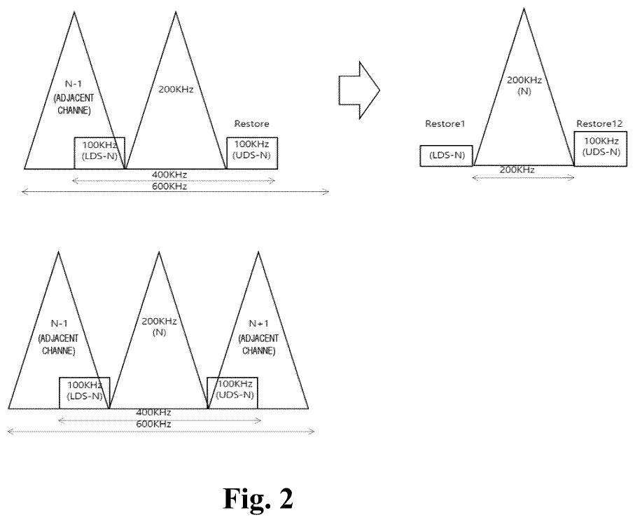

### BEST MODE OF THE INVENTION

Hereinafter, the present embodiments will be described in detail with reference to the accompanying drawings.

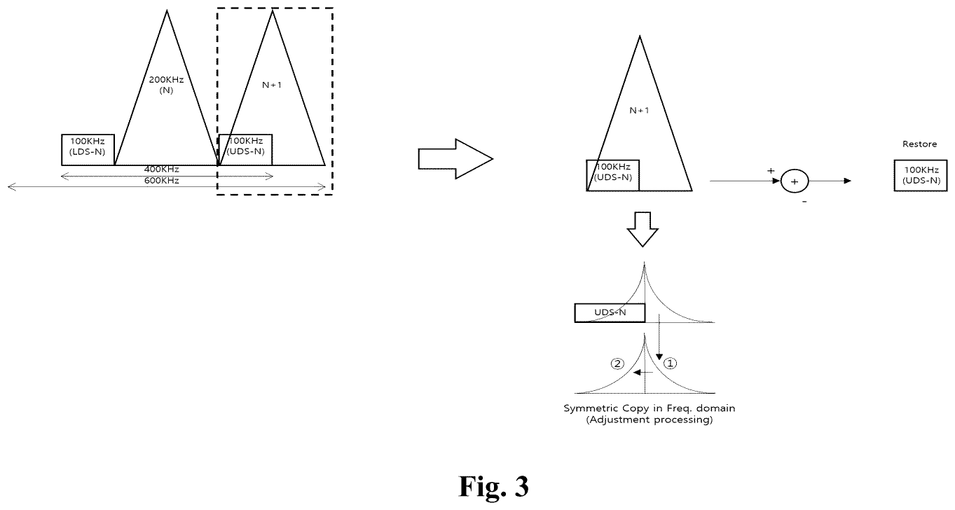

FIG. 3 is a diagram illustrating a method of restoring a signal by eliminating interference occurring with an upper digital sideband (UDS) within an adjacent range of an analog signal using a data folding method according to the present embodiment.

A preprocessing system 800 may recognize interference as noise when the interference occurs with a UDS within an adjacent range of a received analog signal N of Conventional Digital Radio (CDR) or Hybrid Digital Radio (HDR) and restore the signal by eliminating the interference that has occurred with the UDS using a data folding method.

The preprocessing system 800 may recognize interference as noise when the interference occurs within an adjacent range of an analog signal N with respect to CDR having the same spectral structure as HDR and restore the signal by eliminating the interference that has occurred within the adjacent range using a data folding method. Here, the preprocessing system 800 may apply a spectrum spacing with the CDR that is different from a spectrum spacing with the HDR but apply the same concept as the HDR to the CDR to eliminate the interference within the adjacent range of the analog signal.

The preprocessing system 800 receives a radio frequency (RF) signal of CDR or HDR.

The preprocessing system 800 recognizes interference as noise when the interference occurs with the UDS within the adjacent range of the analog signal N of the CDR or HDR and selects an analog signal N+1 that has interfered with the UDS within the adjacent range of the analog signal N.

The preprocessing system 800 uses the symmetry of the analog signal N+1 that has interfered with the UDS to separate the signal into two symmetrical regions (an interference-occurring region (region \textcircled{2} of FIG. 3) and an interference-free region (region \textcircled{1} of FIG. 3)) based on the center.

The preprocessing system 800 performs adjustment processing for symmetrically copying a frequency domain of the interference-free region (region \textcircled{1} of FIG. 3) of the two symmetrical regions onto that of the interference-occurring region (region \textcircled{2} of FIG. 3) to restore the analog signal N+1 of an adjacent channel in which the interference has occurred.

The preprocessing system 800 restores the UDS by subtracting the copied frequency domain of the interference-free region from the frequency domain of the interference-occurring region.

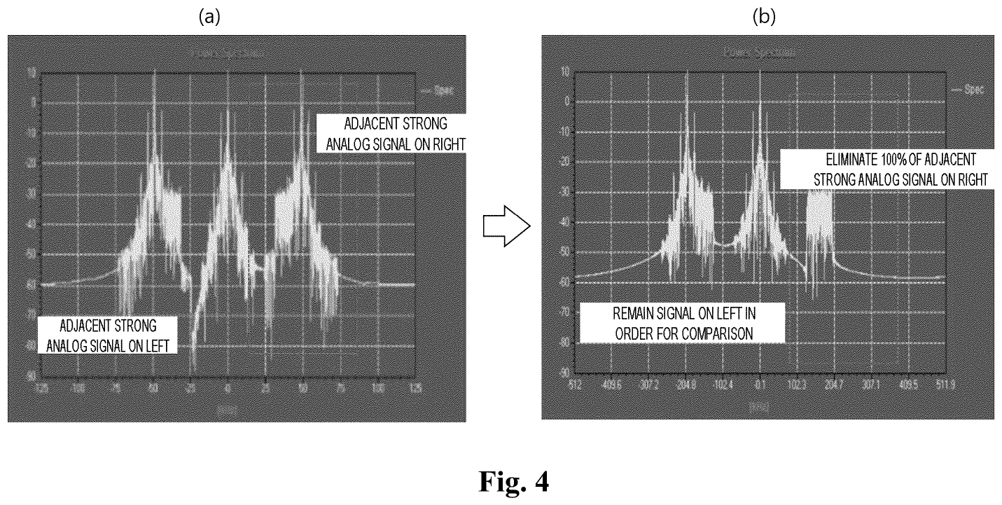

FIG. 4 is a diagram illustrating simulation results for a method of restoring a signal by eliminating interference occurring with a UDS within an adjacent range of an analog signal using a data folding method according to the present embodiment.

The preprocessing system 800 receives an RF signal of CDR or HDR. When interference occurs with the UDS within the adjacent range of the analog signal N of the CDR or HDR, an analog signal N+1 that has interfered with the UDS within the adjacent range of the analog signal N is as illustrated in FIG. 4A.

The preprocessing system 800 uses the symmetry of the analog signal N+1 that has interfered with the UDS to separate the signal into two symmetrical regions based on the center. The signal in which the UDS is restored by subtracting a frequency domain of an interference-free region from a frequency domain of an interference-occurring region, and the analog signal N+1 in which the interference has occurred is restored by performing adjustment processing for symmetrically copying a frequency domain of an interference-free region of the symmetrical regions onto that of an interference-occurring region is as illustrated in FIG. 4B.

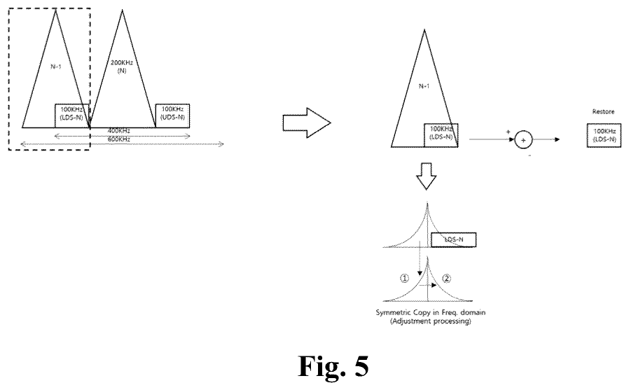

FIG. 5 is a diagram illustrating a method of restoring a signal by eliminating interference occurring with a lower digital sideband (LDS) within an adjacent range of an analog signal using a data folding method according to the present embodiment.

The preprocessing system 800 may recognize interference as noise when the interference occurs with an LDS within an adjacent range of a received analog signal N of CDR or HDR and restore the signal by eliminating the interference that has occurred with the LDS using a data folding method.

The preprocessing system 800 may recognize interference as noise when the interference occurs within an adjacent range of an analog signal N with respect to CDR having the same spectral structure as HDR and restore the signal by eliminating the interference that has occurred within the adjacent range using a data folding method. Here, the preprocessing system 800 may apply a spectrum spacing with the CDR that is different from a spectrum spacing with the HDR but apply the same concept as the HDR to the CDR to eliminate the interference within the adjacent range of the analog signal.

The preprocessing system 800 receives an RF signal of CDR or HDR.

The preprocessing system 800 recognizes interference as noise when the interference occurs with the LDS within the adjacent range of the analog signal N of the CDR or HDR, and selects an analog signal N−1 that has interfered with the LDS within the adjacent range of the analog signal N.

The preprocessing system 800 uses the symmetry of the analog signal N−1 that has interfered with the LDS to separate the signal into two symmetrical regions (an interference-occurring region (region \textcircled{2} of FIG. 5) and an interference-free region (region \textcircled{1} of FIG. 5)) based on the center.

The preprocessing system 800 performs adjustment processing for symmetrically copying a frequency domain of the interference-free region (region \textcircled{1} of FIG. 5) of the two symmetrical regions onto that of the interference-occurring region (region \textcircled{2} of FIG. 5) to restore the analog signal N−1 of an adjacent channel in which the interference has occurred.

The preprocessing system 800 restores the LDS by subtracting the copied frequency domain of the interference-free region from the frequency domain of the interference-occurring region.

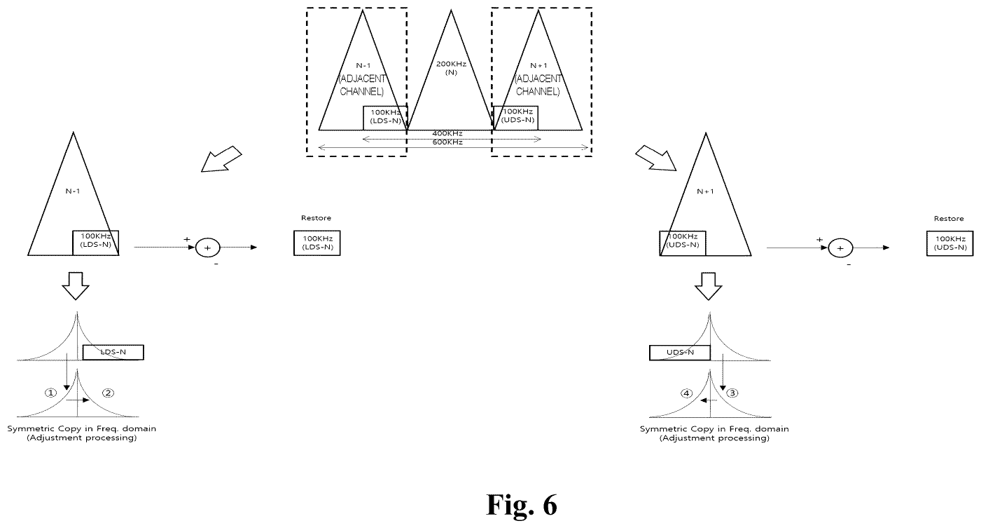

FIG. 6 is a diagram illustrating a method of restoring a signal by eliminating interference occurring with an LDS and a UDS within an adjacent range of an analog signal using a data folding method according to the present embodiment.

The preprocessing system 800 may recognize interference as noise when the interference occurs with an LDS within an adjacent range of a received analog signal N of CDR or HDR and restore the signal by eliminating the interference that has occurred with the LDS using a data folding method.

The preprocessing system 800 may recognize interference as noise when the interference occurs within an adjacent range of an analog signal N with respect to CDR having the same spectral structure as HDR and restore the signal by eliminating the interference that has occurred within the adjacent range using a data folding method. Here, the preprocessing system 800 may apply a spectrum spacing with the CDR that is different from a spectrum spacing with the HDR but apply the same concept as the HDR to the CDR to eliminate the interference within the adjacent range of the analog signal.

The preprocessing system 800 receives an RF signal of CDR or HDR.

The preprocessing system 800 recognizes interference as noise when the interference occurs with the LDS within the adjacent range of the analog signal N of the CDR or HDR, and selects an analog signal N−1 that has interfered with the LDS within the adjacent range of the analog signal N.

The preprocessing system 800 uses the symmetry of the analog signal N−1 that has interfered with the LDS to separate the signal into two symmetrical regions (an interference-occurring region (region \textcircled{2} of FIG. 6) and an interference-free region (region \textcircled{1} of FIG. 6)) based on the center.

The preprocessing system 800 performs adjustment processing for symmetrically copying a frequency domain of the interference-free region (region \textcircled{1} of FIG. 6) of the two symmetrical regions onto that of the interference-occurring region (region \textcircled{2} of FIG. 6) to restore the analog signal N−1 of an adjacent channel in which the interference has occurred.

The preprocessing system 800 restores the LDS by subtracting the copied frequency domain of the interference-free region from the frequency domain of the interference-occurring region.

The preprocessing system 800 recognizes interference as noise when the interference occurs with the UDS within the adjacent range of the analog signal N of the CDR or HDR and selects an analog signal N+1 that has interfered with the UDS within the adjacent range of the analog signal N.

The preprocessing system 800 uses the symmetry of the analog signal N+1 that has interfered with the UDS to separate the signal into two symmetrical regions (an interference-occurring region (region \textcircled{2} of FIG. 6) and an interference-free region (region \textcircled{1} of FIG. 6)) based on the center.

The preprocessing system 800 performs adjustment processing for symmetrically copying a frequency domain of the interference-free region (region \textcircled{1} of FIG. 6) of the two symmetrical regions onto that of the interference-occurring region (region \textcircled{2} of FIG. 6) to restore the analog signal N+1 of an adjacent channel in which the interference has occurred.

The preprocessing system 800 restores the UDS by subtracting the copied frequency domain of the interference-free region from the frequency domain of the interference-occurring region.

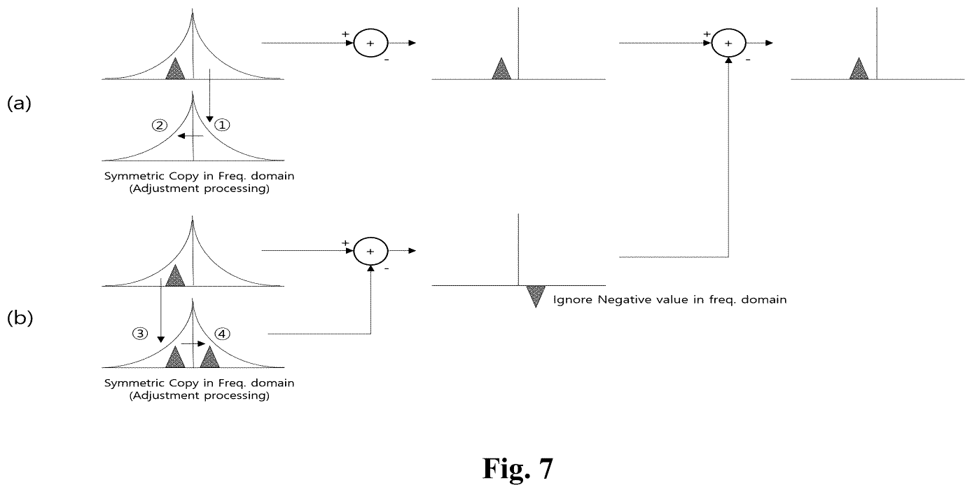

FIG. 7 is a diagram illustrating a starting point of a data folding method according to the present embodiment.

The preprocessing system 800 may use various noise extraction methods. The preprocessing system 800 may additionally determine whether a signal has noise by utilizing a frequency modulation (FM) phase property of the signal restored with the symmetry.

The preprocessing system 800 is not limited to feedback active noise cancellation (FB-ANC) and may be configured with only feed forward active noise cancellation (FF-ANC), and artificial intelligence-based noise cancelling is possible by using a technology in which FB-ANC can be used as an auxiliary.

The preprocessing system 800 may estimate noise using artificial intelligence.

The preprocessing system 800 extracts feature points from each of an n^{th} audio signal and subsequent (n+1)^{th}, (n+2)^{th}, and (n+3)^{th} audio signals stored in a memory after the n^{th} audio signal.

The preprocessing system 800 generates coordinate information on locations at which the extracted feature points are formed in a frequency domain. The preprocessing system 800 inputs coordinate information on each of the generated feature points as input values for a pre-learned artificial neural network. Here, the artificial neural network includes a deep neural network composed of an input layer, a hidden layer, and an output layer.

The preprocessing system 800 estimates a noise signal included in the audio signal input for next signal processing on the basis of an output value of the artificial neural network.

The preprocessing system 800 predicts a location at which the next coordinate information will appear using the artificial neural network on the basis of a movement pattern of the coordinate information on the feature points input to the artificial neural network. The preprocessing system 800 extracts a noise signal having a frequency characteristic corresponding to the predicted appearance location from the audio signal.

The preprocessing system 800 calculates the similarity between the noise signal predicted by the artificial neural network and a noise signal actually detected by a noise detection unit. The preprocessing system 800 adjusts weights between nodes constituting the artificial neural network on the basis of the calculated similarity.

For example, the preprocessing system 800 calculates the similarity between a signal pattern of the noise signal predicted by the artificial neural network and a signal pattern of the noise signal actually detected by the noise detection unit. When the calculated similarity is less than a preset reference similarity, the preprocessing system 800 adjusts the weights between the nodes constituting the artificial neural network until the weights are greater than or equal to the reference similarity.

The preprocessing system 800 may predict noise included in the audio signal using the artificial neural network and additionally cancel noise that is not detected by the noise detection unit, thereby improving performance of noise cancelling.

The preprocessing system 800 may determine the noise using a data folding method when the noise occurs with an LDS within an adjacent range of a received analog signal N of CDR or HDR.

Hereinafter, a method of determining noise occurring within an adjacent range of an analog signal N of CDR or HDR will be described with reference to FIG. 7A.

As illustrated in FIG. 7A, the preprocessing system 800 receives an RF signal of CDR or HDR.

The preprocessing system 800 selects an analog signal N−1 in which the noise has occurred within the adjacent range of the analog signal N when the noise has occurred with the LDS within the adjacent range of the analog signal N of the CDR or HDR.

The preprocessing system 800 uses symmetry of the signal N−1 in which the noise has occurred to separate the signal into two symmetrical regions (a noise-occurring region (region \textcircled{2} of FIG. 7) and a noise-free region (region \textcircled{1} of FIG. 7)) based on the center.

The preprocessing system 800 performs adjustment processing for symmetrically copying a frequency domain of the noise-free region (region \textcircled{1} of FIG. 7A) of the two symmetrical regions onto that of the noise-occurring region (region \textcircled{2} of FIG. 7A) to restore the analog signal N−1 of an adjacent channel in which the noise has occurred.

The preprocessing system 800 subtracts the copied signal in the noise-free region from the signal in the noise-occurring region to separate only the noise from the frequency domain.

Hereinafter, a method of ignoring a negative value in a frequency domain for noise occurring within an adjacent range of an analog signal N of CDR or HDR will be described with reference to FIG. 7B.

As illustrated in FIG. 7B, when the noise occurs with an LDS within an adjacent range of an analog signal N of CDR or HDR, the preprocessing system 800 selects a signal N−1 in which the noise has occurred within the adjacent range of the analog signal N.

The preprocessing system 800 uses the symmetry of the signal N−1 in which the noise has occurred to separate the signal into two symmetrical regions (a noise-occurring region (region \textcircled{3} of FIG. 7B) and a noise-free region (region \textcircled{4} of FIG. 7B)) based on the center.

The preprocessing system 800 performs adjustment processing for symmetrically copying a frequency domain of the noise-occurring region (region \textcircled{3} of FIG. 7B) of the two symmetrical regions onto the noise-free region (region \textcircled{4} of FIG. 7B) to generate a signal of a symmetrical noise-occurring region.

The preprocessing system 800 subtracts the signal of the symmetrical noise-occurring region from the signal of the noise-occurring region. The preprocessing system 800 subtracts the signal of the symmetrical noise-occurring region from the noise-occurring region so that the noise is offset, and outputs a negative value for symmetrical noise from the noise-free region.

The preprocessing system 800 ignores the negative value for the symmetrical noise in the frequency domain.

The preprocessing system 800 separates only noise in the frequency domain by subtracting the signal having the negative value for the symmetrical noise in the frequency domain from a signal from which only the noise is separated in the frequency domain.

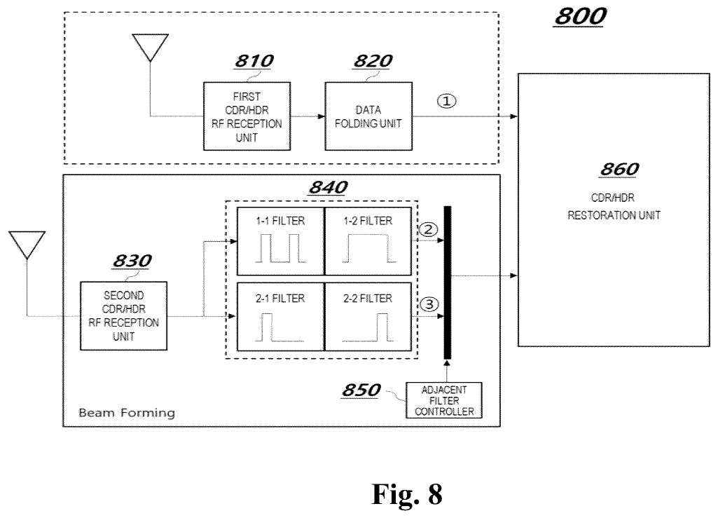

FIG. 8 is a diagram illustrating a process of restoring analog signals of HDR and CDR according to the present embodiment.

The preprocessing system 800 performs maximum ratio combining (MRC) preprocessing using a beamforming method to eliminate interference within an adjacent range of analog signals of CDR/HDR.

The preprocessing system 800 applies a filter to a sideband of a selected channel during a process of receiving digital radio and forms RF beamforming by utilizing a gain difference of automatic gain control (AGC) and may be implemented in a radio receiver in a vehicle, but the present embodiment is not necessarily limited thereto.

The preprocessing system 800 may eliminate interference within an adjacent range of an analog signal through a single path without beamforming (more than 2 paths). The preprocessing system 800 corrects the uncertainty of the analog co-channel residual offset tracking from the RF signal of the CDR or HDR by reflecting a weight.

The preprocessing system 800 has a structure in which beamforming and data folding are combined. The preprocessing system 800 has a structure that simultaneously obtains gain by restoring analog co-channel gain and processing beamforming using the data folding method (1 path).

The preprocessing system 800 additionally includes a noise cancellation module (not illustrated) that tracks and cancels noise included in an RF signal of CDR or HDR received from a first CDR/HDR RF reception unit 810 or a second CDR/HDR RF reception unit 830.

The noise cancellation module includes a noise detection unit (not illustrated) that performs a fast Fourier transform on an RF signal of CDR or HDR to a frequency domain and detects noise from the fast Fourier transformed signal, and a feed forward active noise cancellation (ANC) unit (not illustrated) that cancels the noise detected by the noise detection unit, performs an inverse fast Fourier transform on the RF signal of the CDR or HDR from which the noise has been cancelled to a time domain, and stores the inverse fast Fourier transformed signal in a memory.

The preprocessing system 800 according to the present embodiment includes a first CDR/HDR RF reception unit 810, a data folding unit 820, a second CDR/HDR RF reception unit 830, a filter unit 840, an adjacent filter controller 850, and a CDR/HDR restoration unit 860. The components included in the preprocessing system 800 are not necessarily limited thereto.

The first CDR/HDR RF reception unit 810 receives an RF signal of CDR or HDR.

The data folding unit 820 may recognize interference as noise when the interference occurs with a UDS or LDS within an adjacent range of a received analog signal N of CDR or HDR or when the interference occurs with both the UDS and the LDS and restore the signal by eliminating the interference that has occurred with the UDS using a data folding method.

The data folding unit 820 uses the symmetry of the analog signal N+1 that has interfered with the UDS of the analog signal N of the CDR or HDR to separate the signal into an interference-occurring region and an interference-free region based on the center.

The data folding unit 820 uses the symmetry of the analog signal N−1 that has interfered with the LDS of the analog signal N of the CDR or HDR to separate the signal into an interference-occurring region and an interference-free region based on the center.

The data folding unit 820 uses the symmetry of the analog signals N−1 and N+1 that have interfered with the LDS and UDS of the analog signal N of the CDR or HDR to separate the signals into an interference-occurring region and an interference-free region based on the center.

The data folding unit 820 recognizes interference as noise when the interference occurs with the UDS or LDS within the adjacent range of the analog signal N of the CDR or HDR or when the interference occurs with both the UDS and the LDS, and uses the symmetry of the analog signals N−1 and N+1 in which the interference has occurred using a data folding method to separate the signals into symmetrical regions based on the center.

Hereinafter, a method in which the data folding unit 820 and the CDR/HDR restoration unit 860 restore a signal by eliminating interference occurring with the UDS will be described.

The data folding unit 820 may recognize interference as noise when the interference occurs with a UDS within an adjacent range of a received analog signal N of CDR or HDR and restore the signal by eliminating the interference that has occurred with the UDS using a data folding method.

The data folding unit 820 receives an RF signal of CDR or HDR.

The data folding unit 820 recognizes interference as noise when the interference occurs with the UDS within the adjacent range of the analog signal N of the CDR or HDR and selects an analog signal N+1 that has interfered with the UDS within the adjacent range of the analog signal N.

The data folding unit 820 uses the symmetry of the analog signal N+1 that has interfered with the UDS to separate the signal into two symmetrical regions (an interference-occurring region and an interference-free region) based on the center.

The CDR/HDR restoration unit 860 performs adjustment processing for symmetrically copying a frequency domain of the interference-free region of the two symmetrical regions onto that of the interference-occurring region to restore the analog signal N+1 of an adjacent channel in which the interference has occurred.

The CDR/HDR restoration unit 860 restores the UDS by subtracting the copied frequency domain of the interference-free region from the frequency domain of the interference-occurring region.

Hereinafter, a method in which the data folding unit 820 and the CDR/HDR restoration unit 860 restore a signal by eliminating interference occurring with the LDS will be described.

The data folding unit 820 may recognize interference as noise when the interference occurs with an LDS within an adjacent range of a received analog signal N of CDR or HDR and restore the signal by eliminating the interference that has occurred with the LDS using a data folding method.

The data folding unit 820 receives an RF signal of CDR or HDR.

The data folding unit 820 recognizes interference as noise when the interference occurs with the LDS within the adjacent range of the analog signal N of the CDR or HDR, and selects an analog signal N−1 that has interfered with the LDS within the adjacent range of the analog signal N.

The data folding unit 820 uses the symmetry of the analog signal N−1 that has interfered with the LDS to separate the signal into two symmetrical regions (an interference-occurring region and an interference-free region) based on the center.

The CDR/HDR restoration unit 860 performs adjustment processing for symmetrically copying a frequency domain of the interference-free region of the two symmetrical regions onto that of the interference-occurring region to restore the analog signal N−1 of the adjacent channel in which the interference has occurred.

The CDR/HDR restoration unit 860 restores the LDS by subtracting the copied frequency domain of the interference-free region from the frequency domain of the interference-occurring region.

Hereinafter, a method in which the data folding unit 820 and the CDR/HDR restoration unit 860 restore a signal by eliminating interference occurring with the LDS and the UDS will be described.

The data folding unit 820 may recognize interference as noise when the interference occurs with an LDS within an adjacent range of a received analog signal N of CDR or HDR and restore the signal by eliminating the interference that has occurred with the LDS using a data folding method.

The data folding unit 820 receives an RF signal of CDR or HDR.

The data folding unit 820 recognizes interference as noise when the interference occurs with the LDS within the adjacent range of the analog signal N of the CDR or HDR, and selects an analog signal N−1 that has interfered with the LDS within the adjacent range of the analog signal N.

The data folding unit 820 uses the symmetry of the analog signal N−1 that has interfered with the LDS to separate the signal into two symmetrical regions (an interference-occurring region and an interference-free region) based on the center.

The CDR/HDR restoration unit 860 performs adjustment processing for symmetrically copying a frequency domain of the interference-free region of the two symmetrical regions onto that of the interference-occurring region to restore the analog signal N−1 of the adjacent channel in which the interference has occurred.

The CDR/HDR restoration unit 860 restores the LDS by subtracting the copied frequency domain of the interference-free region from the frequency domain of the interference-occurring region.

The data folding unit 820 recognizes interference as noise when the interference occurs with the UDS within the adjacent range of the analog signal N of the CDR or HDR and selects an analog signal N+1 that has interfered with the UDS within the adjacent range of the analog signal N.

The data folding unit 820 uses the symmetry of the analog signal N+1 that has interfered with the UDS to separate the signal into two symmetrical regions (an interference-occurring region and an interference-free region) based on the center.

The CDR/HDR restoration unit 860 performs adjustment processing for symmetrically copying a frequency domain of the interference-free region of the two symmetrical regions onto that of the interference-occurring region to restore the analog signal N+1 of an adjacent channel in which the interference has occurred.

The CDR/HDR restoration unit 860 restores the UDS by subtracting the copied frequency domain of the interference-free region from the frequency domain of the interference-occurring region.

The second CDR/HDR RF reception unit 830 receives an RF signal of CDR or HDR.

Only a lower sideband signal lower than a center frequency of the RF signal of the CDR or HDR in a selected channel passes the filter unit 840 or only an upper sideband signal higher than the center frequency of the radio signal passes the filter unit 840.

The filter unit 840 includes a 1-1 filter, a 1-2 filter, a 2-1 filter, and a 2-2 filter.

The filter unit 840 may include a plurality of filters that pass only frequencies in specific bands and selectively extract a signal under the control of the adjacent filter controller 850.

Only the lower sideband signal lower than the center frequency of the radio signal in the selected channel passes the filter unit 840 or only the upper sideband signal higher than the center frequency of the radio signal passes the filter unit 840 using any one of the 1-1 filter, the 1-2 filter, the 2-1 filter, and the 2-2 filter.

When the filter unit 840 has the characteristics of the 2-1 filter, the filter unit 840 may allow all energy of the FM and N+1 adjacent signals of an original signal to be transmitted to the LDS to amplify the signal.

When the filter unit 840 has the characteristics of the 2-2 filter, the filter unit 840 may allow all energy of the FM and N−1 adjacent signals of the original signal to be transmitted to the UDS to amplify the signal.

When the filter unit 840 has the characteristics of the 1-1 filter, the filter unit 840 may allow some energy of the FM and N+1/N−1 adjacent signals of the original signal to be transmitted to the UDS to amplify the signal.

When the filter unit 840 has the characteristics of the 1-2 filter, the filter unit 840 may allow some energy of the FM and N+1/N−1 adjacent signals of the original signal to be transmitted to the original signal.

The adjacent filter controller 850 controls the filter unit 840 to select any one of the 1-1 filter, the 1-2 filter, the 2-1 filter, and the 2-2 filter.

The CDR/HDR restoration unit 860 restores the signal by eliminating interference on the basis of symmetrical regions.

The CDR/HDR restoration unit 860 performs beamforming for the selected channel on the basis of a difference in gain values between a signal that has passed through the filter unit 840 and the original signal that has not passed through the filter unit 840. The CDR/HDR restoration unit 860 performs beamforming and restores the signal using a gain difference of AGC.

The CDR/HDR restoration unit 860 processes the signal using a maximum ratio combining (MRC) algorithm. The MRC algorithm is a technique that weights the good part of the channel when a maximum amount is generated according to the phase control.

The CDR/HDR restoration unit 860 may restore the LDS from the LDS and the LDS adjacent signal. The CDR/HDR restoration unit 860 may restore the UDS from the UDS and the UDS adjacent signal. The CDR/HDR restoration unit 860 may reflect a channel status information (CSI) channel weight with a low probability as much as a frequency offset (as much as overlapping occurred) that occurred in the FM phase tracking.

The CDR/HDR restoration unit 860 performs adjustment processing for symmetrically copying a frequency domain of the interference-free region onto that of the interference-occurring region to restore the analog signal N+1 in which the interference has occurred and restores the UDS by subtracting the copied frequency domain of the interference-free region from the frequency domain of the interference-occurring region.

The CDR/HDR restoration unit 860 performs adjustment processing for symmetrically copying the frequency domain of the interference-free region onto that of the interference-occurring region to restore the analog signal N−1 in which the interference has occurred and restores the LDS by subtracting the copied frequency domain of the interference-free region from the frequency domain of the interference-occurring region.

The CDR/HDR restoration unit 860 performs adjustment processing for symmetrically copying the frequency domain of the interference-free region onto that of the interference-occurring region to restore the analog signals N−1 and N+1 in which the interference has occurred and restores the LDS and the UDS by subtracting the copied frequency domain of the interference-free region from the frequency domain of the interference-occurring region.

The CDR/HDR restoration unit 860 performs beamforming for the selected channel on the basis of the difference in gain values between the signal that has passed through the filter unit 840 and the original signal that has not passed through the filter unit 840.

The above description is only an example describing the technical spirit of the present embodiment. Various changes and modifications may be made without departing from the spirit and scope of the present embodiment by those skilled in the art. Therefore, the present embodiments and the accompanying drawings should be considered in a descriptive sense only and not for limiting the technological scope. The technical spirit of the present embodiment is not limited by these embodiments and the accompanying drawings. It should be understood that the scope of the present embodiment is interpreted according to the appended claims and encompasses all equivalent technological scopes.

### MODE OF THE INVENTION

Modes of the invention have been described together in the above Best Mode of the Invention.

### INDUSTRIAL APPLICABILITY

The present invention has industrial applicability because it makes it possible to eliminate interference within an adjacent range of analog signals through a single path without beamforming (two or more paths).

1. A preprocessing system comprising:
a Conventional Digital Radio (CDR)/Hybrid Digital Radio (HDR) radio frequency (RF) reception unit configured to receive an RF signal of CDR or HDR;
a data folding unit configured to recognize interference as noise when the interference occurs in an upper digital sideband (UDS) or lower digital sideband (LDS) within an adjacent range of an analog signal (N) of the CDR or HDR or when interference occurs in both the UDS and the LDS and use symmetry of analog signals (N−1 and N+1) in which the interference has occurred to separate the analog signals into symmetrical regions based on a center of the analog signals by using a data folding method; and
a CDR/HDR restoration unit configured to restore a signal by eliminating the interference on the basis of the symmetrical regions,
wherein the data folding unit uses the symmetry of the analog signal (N+1) that has interfered with the UDS of the analog signal N of the CDR or HDR to separate the analog signal into an interference-occurring region and an interference-free region based on the center, and
the CDR/HDR restoration unit performs adjustment processing for symmetrically copying a frequency domain of the interference-free region onto that of the interference-occurring region to restore the analog signal (N+1) in which the interference has occurred and restores the UDS by subtracting the copied frequency domain of the interference-free region from the frequency domain of the interference-occurring region.

2. A preprocessing system comprising:
a Conventional Digital Radio (CDR)/Hybrid Digital Radio (HDR) radio frequency (RF) reception unit configured to receive an RF signal of CDR or HDR;
a data folding unit configured to recognize interference as noise when the interference occurs in an upper digital sideband (UDS) or lower digital sideband (LDS) within an adjacent range of an analog signal (N) of the CDR or HDR or when interference occurs in both the UDS and the LDS and use symmetry of analog signals (N−1 and N+1) in which the interference has occurred to separate the analog signals into symmetrical regions based on a center of the analog signals by using a data folding method; and
a CDR/HDR restoration unit configured to restore a signal by eliminating the interference on the basis of the symmetrical regions,
wherein the data folding unit uses the symmetry of the analog signal (N−1) that has interfered with the LDS of the analog signal (N) of the CDR or HDR to separate the analog signal into an interference-occurring region and an interference-free region based on the center, and
the CDR/HDR restoration unit performs adjustment processing for symmetrically copying a frequency domain of the interference-free region onto that of the interference-occurring region to restore the analog signal (N−1) in which the interference has occurred and restores the LDS by subtracting the copied frequency domain of the interference-free region from the frequency domain of the interference-occurring region.

3. A preprocessing system comprising:
a Conventional Digital Radio (CDR)/Hybrid Digital Radio (HDR) radio frequency (RF) reception unit configured to receive an RF signal of CDR or HDR;
a data folding unit configured to recognize interference as noise when the interference occurs in an upper digital sideband (UDS) or lower digital sideband (LDS) within an adjacent range of an analog signal (N) of the CDR or HDR or when interference occurs in both the UDS and the LDS and use symmetry of analog signals (N−1 and N+1) in which the interference has occurred, to separate the analog signals into symmetrical regions based on a center of the analog signals by using a data folding method; and
a CDR/HDR restoration unit configured to restore a signal by eliminating the interference on the basis of the symmetrical regions,
wherein the data folding unit uses the symmetry of the analog signals (N−1 and N+1) that have interfered with the LDS and UDS of the analog signal (N) of the CDR or HDR to separate the analog signal into an interference-occurring region and an interference-free region based on the center, and
the CDR/HDR restoration unit performs adjustment processing for symmetrically copying a frequency domain of the interference-free region onto that of the interference-occurring region to restore the analog signals (N−1 and N+1) in which the interference has occurred and restores the LDS and the UDS by subtracting the copied frequency domain of the interference-free region from the frequency domain of the interference-occurring region.

4. The preprocessing system of claim 1, further comprising a filter unit that allows only a lower sideband signal lower than a center frequency of the RF signal of the CDR or HDR in a selected channel to pass or allows only an upper sideband signal higher than the center frequency of the radio signal to pass,
wherein the CDR/HDR restoration unit performs beamforming for the selected channel on the basis of a difference in gain values between a signal that has passed through the filter unit and an original signal that has not passed through the filter unit.

5. The preprocessing system of claim 4, further comprising a noise cancellation module configured to track and cancel noise included in the RF signal of the CDR or HDR received from the CDR/HDR RF reception unit,
wherein the noise cancellation module includes:
a noise detection unit that performs a fast Fourier transform on the RF signal of the CDR or HDR to a frequency domain and detects noise from the fast Fourier transformed signal; and
a feed forward active noise cancellation (ANC) unit that cancels the noise detected by the noise detection unit, performs an inverse fast Fourier transform on the RF signal of the CDR or HDR from which the noise has been cancelled to a time domain, and stores the inverse fast Fourier transformed signal in a memory.
